(19) United States
(12) Patent Application Publication
(10) Pub. No.: US 2024/0040057 A1
(43) Pub. Date: Feb. 1, 2024

(54) INFORMATION PROCESSING APPARATUS, METHOD FOR CONTROLLING THE SAME, AND STORAGE MEDIUM

(71) Applicant: CANON KABUSHIKI KAISHA, Tokyo (JP)

(72) Inventor: KYOHEI TAKEDA, Tokyo (JP)

(21) Appl. No.: 18/355,045

(22) Filed: Jul. 19, 2023

(30) Foreign Application Priority Data
Jul. 22, 2022 (JP) 2022-117536

(51) Int. Cl. H04N 1/44; H04N 1/00

(52) U.S. Cl. CPC H04N 1/4413; H04N 1/00392; H04N 1/00413; H04N 1/00411; H04N 2201/0094

(57) ABSTRACT

In a case where there is a touch on an operation unit within a predetermined time after a touched state of the operation unit is released, a control unit performs input control to recognize a locus of a touched position of the operation unit, assuming that the touched state continues without being released.

### BACKGROUND OF THE DISCLOSURE

### Field of the Disclosure

The present disclosure relates to an information processing apparatus that performs pattern authentication, a method for controlling the information processing apparatus, and a storage medium.

### Description of the Related Art

In recent years, authentication methods for devices such as multifunction peripherals have diversified. As one of the authentication methods, there is known an authentication method called pattern authentication in which a pattern (a locus) drawn by a finger moved along a touch panel by a user is compared with a pre-registered pattern to determine whether these patterns match each other, as discussed in Japanese Patent Application Laid-Open No. 2016-170721.

In the pattern authentication method, ease of authentication depends on the type of operation panel. In general, an electrostatic panel used in a smartphone or the like is compatible with an operation process of moving a finger along the panel because the panel detects an electric current change caused by a finger touch and performs processing.

In contrast, a pressure-sensitive panel used in an apparatus such as an automatic telling machine (ATM) of a bank or an image forming apparatus recognizes the pressure of a press on the panel and performs processing. Thus, even though a user thinks the user is moving a finger along the panel, the panel can determine that the finger has been released and the user can fail to draw a pattern.

### SUMMARY OF THE DISCLOSURE

The present disclosure is directed to a mechanism for enhancing usability in an operation of drawing a pattern by moving a finger along a panel.

According to an aspect of the present disclosure, an information processing apparatus includes one or more processors, and at least one memory coupled to the one or more processors and having stored thereon instructions, which when executed by the one or more processors, cause the information processing apparatus to perform control to input pattern information in response to an input operation of touching an operation unit and moving a touched position of the operation unit while maintaining a touched state of the operation unit, the pattern information being determined based on a locus of the touched position. In a case where there is a touch on the operation unit within a predetermined time after the touched state is released, input control to recognize the locus of the touched position is performed assuming that the touched state continues without being released.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of a system including an image forming apparatus (a multifunction peripheral (MFP)) according to an exemplary embodiment.

FIG. 2 is a block diagram illustrating an example of a hardware configuration of the MFP.

FIG. 3 is a block diagram illustrating an example of a software configuration of the MFP.

FIG. 4 is a diagram illustrating an example of a user interface (UI) of the MFP.

FIG. 5 is a diagram illustrating an example of the UI of the MFP.

FIGS. 6A and 6B are diagrams each illustrating an example of the UI of the MFP.

FIG. 7 is a diagram illustrating an example of an operation procedure and a screen transition in registering a pattern to be used for user authentication.

FIG. 8 is a diagram illustrating an example of a screen transition in a case where a user who has already registered pattern information logs in to the MFP by using integrated circuit (IC) card authentication and pattern authentication.

FIG. 9 is a flowchart illustrating an operation performed during pattern input in a pattern authentication screen.

FIG. 10 is a diagram illustrating logic of determining selection of a dot in the pattern authentication.

FIG. 11 is a flowchart illustrating a detailed operation in release event processing in the pattern authentication screen.

FIG. 12 is a diagram illustrating an example of a re-input acceptance setting screen in the pattern authentication.

FIG. 13 is a diagram illustrating an example of switching between screen displays during the pattern input in the pattern authentication.

FIG. 14 is a diagram illustrating an example of internal allocation to the pattern information.

### DESCRIPTION OF THE EMBODIMENTS

An exemplary embodiment of the present disclosure will be described below with reference to the drawings. As an example of an image forming apparatus to which the present exemplary embodiment is applied, a multifunction peripheral (MFP) having functions such as copy, print, and scan will be described.

### <System Configuration>

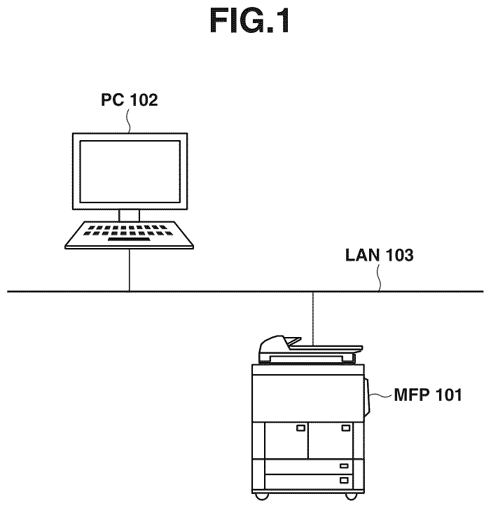

FIG. 1 illustrates an example of a configuration of a system including an image forming apparatus (an MFP 101) that is an example of an information processing apparatus according to the present exemplary embodiment.

The MFP 101 is an example of the image forming apparatus according to the present exemplary embodiment. The MFP 101 can receive a print job from a terminal (e.g., a personal computer (PC) 102) connected to the MFP 101 via a local area network (LAN) 103.

The PC 102 is an information processing apparatus.

### <Hardware Configuration>

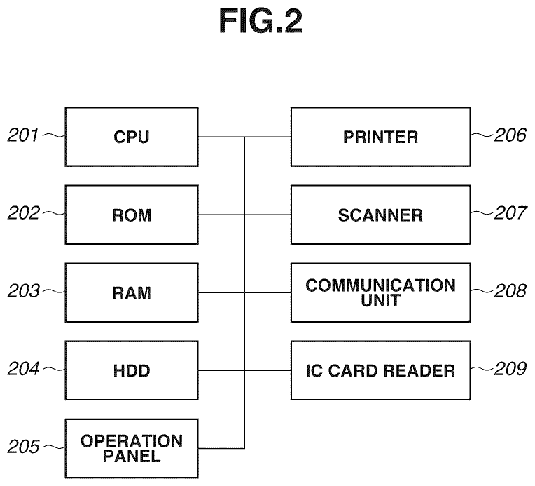

FIG. 2 is a block diagram illustrating an example of a hardware configuration of the MFP 101.

A central processing unit (CPU) 201 is a processor that controls an entire operation of the MFP 101. A random access memory (RAM) 203 is a volatile memory and is used as a temporary storage area for loading various control programs stored in a read only memory (ROM) 202 and a hard disk drive (HDD) 204.

The ROM 202 is a nonvolatile memory and stores programs including a boot program of the MFP 101. The HDD 204 is a nonvolatile memory having a large capacity compared with the ROM 202. The HDD 204 stores control programs for the MFP 101. The HDD 204 also stores an operating system (OS) and application programs. In place of or together with the HDD 204, any other storage device such as a solid state drive (SSD) can be used.

The CPU 201 executes the boot program stored in the ROM 202 at the time of activation of the MFP 101. The boot program is intended to read out a program of the OS stored in the HDD 204 and load the program into the RAM 203. Upon executing the boot program, the CPU 201 executes the program of the OS loaded into the RAM 203 and controls the MFP 101. The CPU 201 also stores, on the RAM 203, data to be used for an operation using a control program, and reads and writes the data.

In the present exemplary embodiment, the MFP 101 has a configuration where one CPU 201 performs each processing in flowcharts (described below), but other configurations can be used. For example, a plurality of CPUs or microprocessors (micro processing units (MPUs)) can cooperate with each other to perform each processing in the flowcharts (described below). Alternatively, a part of the processing (described below) can be performed using a hardware circuit such as an application specific integrated circuit (ASIC) or a field-programmable gate array (FPGA).

An operation panel 205 includes a display (a touch panel) on which a touch operation can be performed, and is an operation unit that can be operated by the touch of a finger or a stylus. In the following, an example in which a user performs an operation with a finger will be described as an example, but the description also applies to an operation with a stylus or the like.

A printer 206 is a printer engine that prints print data received from an external apparatus via a communication unit 208 and digital data acquired from a scanner 207. The scanner 207 is a scanner device that scans a paper document to convert the scanned document into digital data.

The communication unit 208 is a network interface for communicatively connecting to the Internet or a LAN of an office.

An IC card reader 209 is a device for reading out information to be used for user authentication from an IC card, and is a unit essential for implementing IC card authentication.

In the present exemplary embodiment, the multifunction peripheral (the MFP 101) having a printer function and a scanner function will be described as an example. However, the present exemplary embodiment is not limited to the multifunction peripheral and is applicable to any type of information processing apparatus as long as the information processing apparatus includes an operation panel that can accept input of pattern information.

### <Software Configuration>

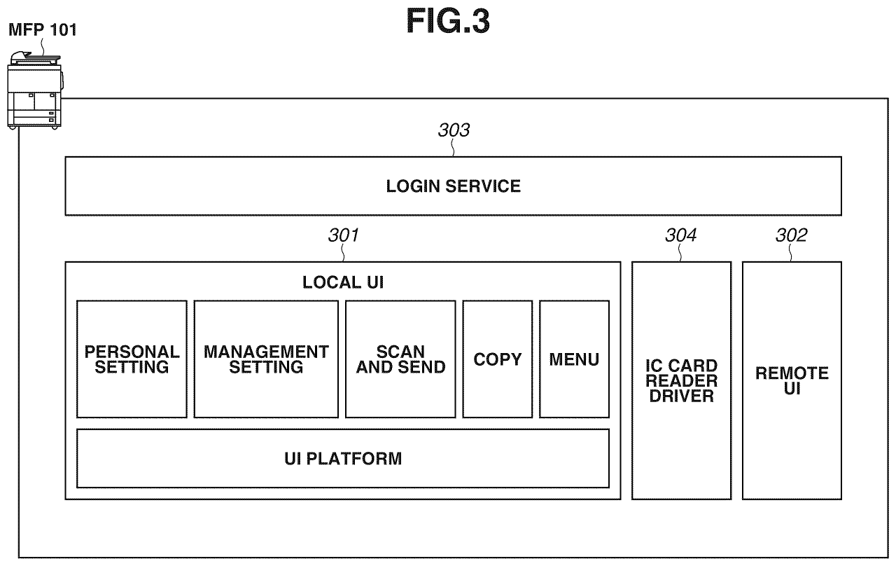

FIG. 3 is a block diagram illustrating an example of a software configuration of the MFP 101. The software configuration illustrated in FIG. 3 corresponds to functions implemented by the CPU 201 loading the programs stored in the ROM 202 or the HDD 204 into the RAM 203 and executing the programs as appropriate.

In the MFP 101, a local UI 301 provides a user interface (UI) to be displayed on the display of the operation panel 205. The local UI 301 includes functions related to a user's personal setting and a management setting, a menu for enabling a user to select a function, and a UI platform for controlling applications and a screen transition. The applications include, for example, a copy application that provides a copy function to a user by controlling the printer 206 or the scanner 207, and an application that provides a function of transmitting a scanned document by controlling the scanner 207 and the communication unit 208.

A remote UI 302 has a Hypertext Transfer Protocol (HTTP) server function and provides a UI created using the HyperText Markup Language (HTML) to a remote access user. The user can change a setting of the MFP 101 or use a function of the MFP 101 by accessing the remote UI 302 using a web browser of a PC terminal.

A login service 303 is a software module that authenticates a user who uses the local UI 301 or the remote UI 302.

An IC card reader driver 304 controls the IC card reader 209. The IC card reader driver 304 acquires information from an IC card via the IC card reader 209 and provides the IC card information to the login service 303.

### <User Account>

User accounts managed by the login service 303 will now be described.

The login service 303 stores user accounts in a user account table as indicated by Table 1 to manage the user accounts. The user account table (Table 1) is a database recorded in the HDD 204. The user account table can be managed using a database at another node on the network after a communication path and a storage are encrypted and tampering prevention measures are taken. In the user account table, user names, passwords, card identifiers (ID) to be used for IC card authentication, patterns, roles, and e-mail addresses are recorded. The structure of the user account table is not limited to that in Table 1.

TABLE 1

| User Name | Password | Card ID | Pattern | Role | E-Mail Address |
|---|---|---|---|---|---|
| Admin | ******** | F1EABB15 . . . | 489523 | Administrator | admin@canon.com |
| Alice | ******** | 44E7158E . . . | 012369cde | Administrator | alice@canon.com |
| Bob | ******** | 045BB438 . . . | | General User | bob@canon.com |
| Carol | ******** | 19E313B6 . . . | | General User | carol@canon.com |
| Dave | ******** | BDFDB35 . . . | | Limited User | dave@canon.com |

In the user account table, “User Name” indicates identification information for identifying a user. “Password” indicates a password to be entered by a user when the user is authenticated using user's identification information and password. “E-mail” indicates an e-mail address of a user. In place of or together with the e-mail address, any other contact information such as a telephone number can be used. “Role” indicates information about authority of a user to use the MFP 101. An example of each role and the use authority is indicated by the following role information table (Table 2). In addition to the roles defined in the MFP 101 before being shipped from a factory, a user may be able to set detailed use authority and create a new role.

TABLE 2

| Role | Authority |
|---|---|
| Administrator | Setting change permitted, Color printing permitted, |
| | Address book editing permitted |
| General User | Setting change prohibited, Color printing permitted, |
| | Address book reference permitted |
| Limited User | Setting change prohibited, Color printing prohibited, |
| | Address book reference prohibited |

### <User Authentication Function>

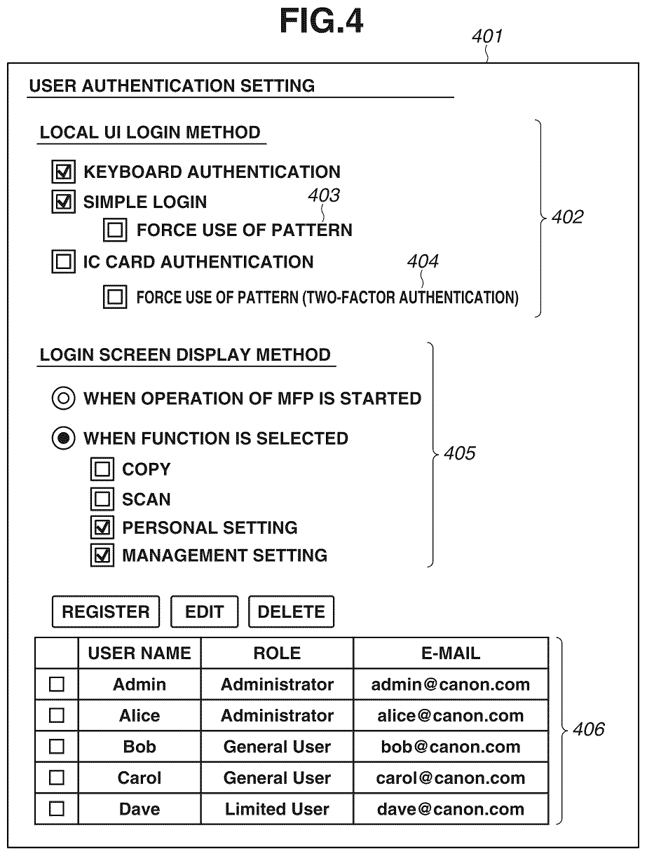

A user authentication function of the MFP 101 will be described next with reference to FIGS. 4, 5, 6A, and 6B.

FIGS. 4, 5, 6A, and 6B each illustrate an example of a UI of the MFP 101.

FIG. 4 corresponds to an example of a UI of the MFP 101 for a user authentication setting, which is provided by the remote UI 302. Not only the remote UI 302 but also the local UI 301 can provide a similar UI to an administrator.

A remote UI screen 401 is used to perform the user authentication setting, and only a user having the role of Administrator can access the remote UI screen 401. Although not illustrated, the remote UI 302 displays a login screen created using the HTML by the login service 303, to a user who accesses the remote UI 302. The remote UI 302 performs authentication of the user based on a user name and a password in the login screen for access, determines whether the user is permitted to access the remote UI screen 401, and controls display of the remote UI screen 401.

The remote UI screen 401 includes, as setting fields, a local UI login method 402, a login screen display method 405, and user management 406. The details will be described next.

The local UI login method 402 is an example of a UI for setting a login method for the local UI 301. As the login method, one or more login methods can be selected from among “keyboard authentication”, “simple login”, and “IC card authentication”. Each of the login methods will be described next.

### <Keyboard Authentication>

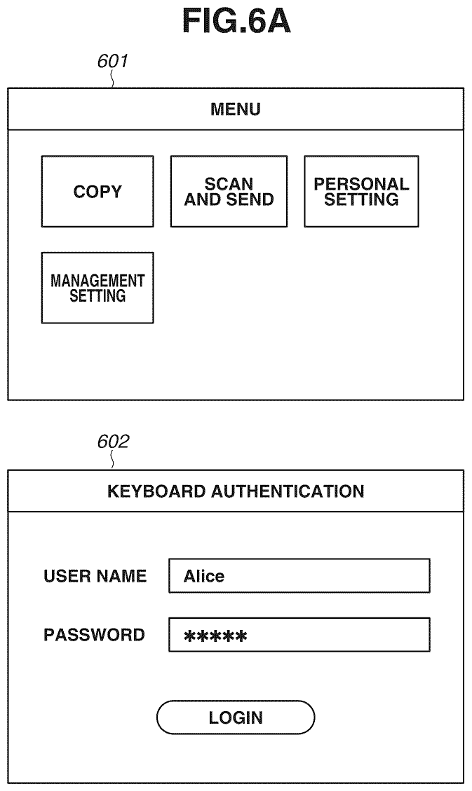

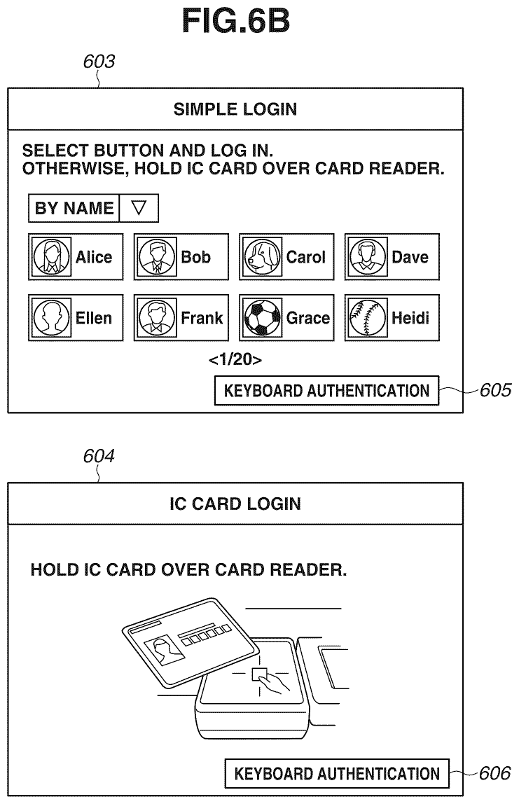

In the keyboard authentication method, a user logs in to the MFP 101 by entering a user name and a password in a login screen. A login screen 602 illustrated in FIG. 6A is an example of the login screen for keyboard authentication.

To enter a user name and a password in the login screen 602 for the keyboard authentication, a user uses hardware keys included in the MFP 101 or software keys (not illustrated).

### <Simple Login>

In the simple login method, a button corresponding to a registered user is displayed in a login screen. An avatar icon image and a user name of the user are displayed on the button. The user logs in to the MFP 101 by selecting the button corresponding to the avatar of the user. The simple login method can be used in combination with a pattern authentication method in order to prevent an unauthorized login. In a case where a user sets a pattern for pattern authentication, the user is identified based on a selected button, and the pattern authentication is performed for the identified user.

A setting 403 for forcing the use of a pattern is used by an administrator to force the use of the pattern authentication at the time of using the simple login. By enabling the setting 403 for forcing the use of a pattern, it is possible to force every user to use a pattern. In a case where the use of a pattern is not forced, each user can optionally use a pattern. The details of the pattern authentication will be described below.

A simple login screen 603 illustrated in FIG. 6B is an example of the login screen for the simple login.

In a case where the keyboard authentication is enabled in addition to the simple login, a button 605 for displaying the keyboard authentication screen (the login screen 602 for the keyboard authentication) is displayed in the simple login screen 603. The user can change the login method to the keyboard authentication by pressing the button 605.

In a case where the IC card authentication is enabled in addition to the simple login, the user can hold an IC card over the IC card reader 209 instead of pressing the button corresponding to the user, whereby the user can be identified from the IC card held over the IC card reader 209.

### <IC Card Authentication>

In the IC card authentication method, user authentication is performed using an IC card. A login screen 604 illustrated in FIG. 6B is an example of a login screen for the IC card authentication.

In the IC card authentication, a card ID is acquired from an IC card held over the IC card reader 209, and a user associated with the card ID is identified by referring to a user information table, so that the user is allowed to log in to the MFP 101. The IC card authentication can be used in combination with the pattern authentication in order to prevent unauthorized use or forgery of the IC card by another person. In a case where the user sets a pattern, the pattern authentication is performed for the user identified from the card ID after the IC card authentication. In this way, a combination of authentication of an IC card possession factor and authentication of a pattern knowledge factor can be used as a two-factor authentication function.

A setting 404 for forcing the use of a pattern (a two-factor authentication setting) is used by an administrator to force the use of the pattern authentication at the time of using the IC card authentication. By enabling the setting 404 for forcing the use of a pattern (the two-factor authentication setting), it is possible to force every user to use a pattern. In a case where the use of a pattern is not forced, each user can optionally use a pattern. In a case where the administrator intends to force the use of the two-factor authentication, the administrator forces the use of a pattern by enabling the setting 404 for forcing the use of a pattern (the two-factor authentication setting) and also disables “keyboard authentication” and “simple login” which do not correspond to the two-factor authentication. The details of the pattern authentication will be described below.

The login screen display method 405 is an example of a UI for setting the timing for displaying a login screen. As the timing for displaying a login screen, either “when operation of MFP is started” or “when function is selected” can be set.

In a case where “when function is selected” is set, a function requiring a login is further selected and set. For example, “when function is selected” is selected by default and “personal setting” and “management setting” are also set by default as the functions requiring authentication before shipment of the MFP 101 from the factory. In a case where “when function is selected” is set, a menu screen 601 illustrated in FIG. 6A is displayed when the MFP 101 is activated. When a user selects a function requiring authentication (“personal setting” or “management setting” in the present exemplary embodiment) in the menu screen 601, the login screen (the login screen 602 in FIG. 6A, the simple login screen 603 in FIG. 6B, or the login screen 604 in FIG. 6B) is displayed to authenticate the user.

In a case where “when operation of MFP is started” is set, the login screen (the login screen 602, the simple login screen 603, or the login screen 604) is displayed when the MFP 101 is activated, and every user who intends to use the menu screen 601 of the MFP 101 is requested to be authenticated. In a case where the user performs a login operation in the login screen and has successfully been authenticated, the menu screen 601 is displayed.

### <User Management>

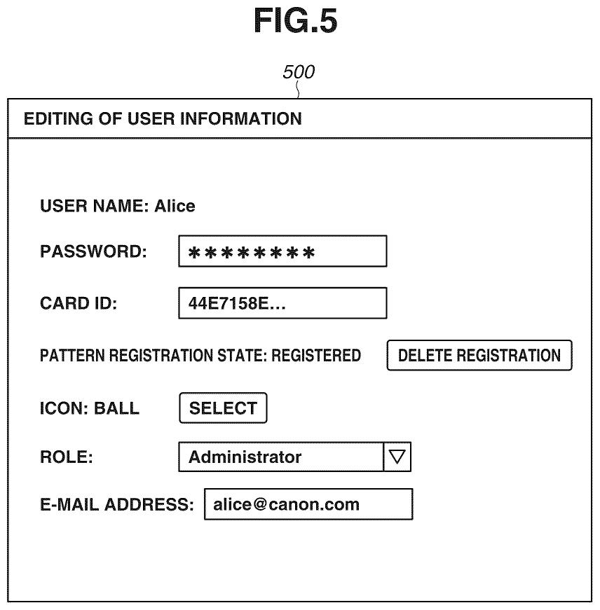

The user management 406 is an example of a UI for managing the accounts of users who use the MFP 101. The user management 406 provides functions of registering a new user account and selecting a registered account to edit or delete the selected account. For example, in a case where an administrator having the user name “Admin” selects (checks a check box) of the account of the user name “Alice” in the user management 406 and presses an edit button, the remote UI 302 displays a user edit screen 500 illustrated in FIG. 5.

In the user edit screen 500, a password, a card ID, a role, an e-mail address, and an icon (an icon image displayed on the button in the simple login) can be edited and saved. The user edit screen 500 also provides a function of displaying a pattern registration status (a pattern registration state) in order for the administrator to keep track of the pattern registration status of each general user.

The user edit screen 500 also provides a function of deleting a registered pattern (a pattern deletion function) considering a case where a general user who has forgotten the registered pattern requests an administrator to reset the pattern.

A pattern is assumed to be registered by each general user via the local UI 301. Thus, a function enabling an administrator to register a pattern for another person is not provided.

### <Pattern Registration Method>

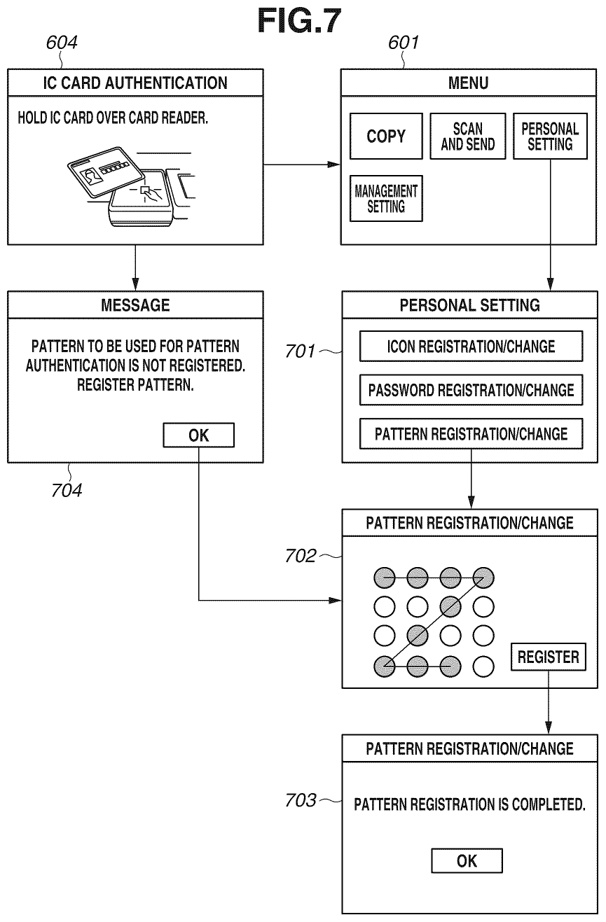

Registration of a pattern to be used for authentication will be described next with reference to FIG. 7.

FIG. 7 illustrates an example of an operation procedure and a screen transition in registering a pattern to be used for user authentication. A description will be given assuming a case where “IC card authentication” is set as the local UI login method 402, and “when operation of MFP is started” is set as the login screen display method 405.

### <Case Where Setting for Forcing Use of Pattern Authentication (Two-Factor Authentication Setting) Is Disabled>

An operation procedure and a screen transition in a case where the setting 404 for forcing the use of the pattern authentication (the two-factor authentication setting) is disabled will be described.

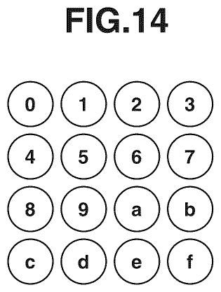

A user performs a login to the MFP 101 by holding an IC card of the user over the IC card reader 209 in a state where the login screen 604 for the IC card authentication is displayed. When the user has successfully logged in to the MFP 101, the menu screen 601 is displayed. In a case where the user wishes to use the pattern authentication, the user selects “personal setting” from the menu, so that a personal setting screen 701 appears. “Personal setting” provides functions of registering and changing the authentication information and profile of each user. For example, the personal setting screen 701 provides functions such as “icon (avatar icon image) registration/change”, “password registration/change”, and “pattern registration/change”. When the user selects “pattern registration/change” in the personal setting screen 701, a pattern registration/change screen 702 appears. For example, the pattern registration/change screen 702 displays a total of 16 dots (display objects) in four rows and four columns to enable the user to draw a desired shape with a finger on a screen area where the dots are displayed. In this case, the user can be requested to input the same shape a plurality of times in order to confirm the input and prevent an input error by the user. For example, the login service 303 acquires the dots that the finger of the user has passed and the order of the dots as pattern information, and stores the pattern information in “Pattern” of the user account table (Table 1) in association with the account of the logged-in user. For the pattern information, for example, numbers and alphabets can be internally allocated to 16 (4×4) dots as illustrated in FIG. 14.

FIG. 14 illustrates an example of the internal allocation to the pattern information.

For example, a pattern shape (pattern information) illustrated in the pattern registration/change screen 702 in FIG. 7 can be expressed by “012369cde”. The pattern information is encrypted before being stored in “Pattern” of the user account table (Table 1). Alternatively, the pattern information can be converted into a digest using a hash function and the digest can be stored. In general, generation of a digest using Password-Based Key Derivation Function 2 (PBKDF2) is recommended. Thus, a salt used for PBKDF2 and a digest calculated by PBKDF2 can be stored.

When the pattern information has successfully been registered in the pattern registration/change screen 702, the login service 303 displays a screen 703 indicating completion of the registration. When an “OK” button is touched, the screen 703 is closed. Closing the screen 703 returns the user to the personal setting screen 701.

### <Case Where Setting for Forcing Use of Pattern Authentication (Two-Factor Authentication Setting) Is Enabled>

An operation procedure and a screen transition in a case where the setting 404 for forcing the use of the pattern authentication (the two-factor authentication setting) is enabled will be described.

A user tries to log in to the MFP 101 by holding an IC card of the user over the IC card reader 209 in a state where the login screen 604 for the IC card authentication is displayed. At this time, in a case where the card ID of the IC card has already been registered in association with the user's account but the pattern information to be associated with the account has not been registered, the login service 303 displays a message requesting registration of a pattern on a screen 704 to direct the user to the pattern registration/change screen 702. In a case where the pattern registration is completed by the user, the login service 303 displays the screen 703 indicating the completion of the registration. When the user closes the screen 703, the login of the user is completed and the login service 303 displays the menu screen 601. In order for the user to confirm the pattern input in the pattern registration/change screen 702, a screen displaying dots can be displayed again after the pattern registration/change screen 702 is displayed, so that the user can input the same pattern as the pattern input in the pattern registration/change screen 702.

In a case where “simple login” is selected as the local UI login method 402, the simple login screen 603 illustrated in FIG. 6B appears instead of the login screen 604 for the IC card authentication, in the screen transition in FIG. 7. In this case, in the simple login screen 603, a user account is identified based on the button selected by the user instead of using the IC card. The screen to be displayed after the user is identified and the operation procedure for the pattern registration are similar between when using “IC card authentication” and when using “simple login”.

### <Detailed Operation in Pattern Authentication>

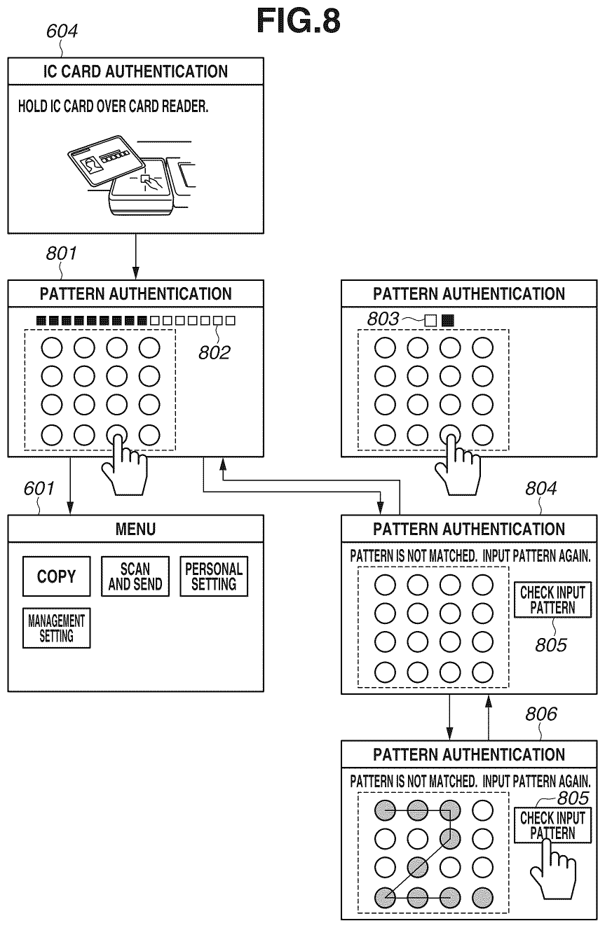

An operation in the pattern authentication will be described next with reference to FIGS. 8 to 13.

FIG. 8 illustrates an example of a screen transition in a case where a user who has already registered pattern information logs in to the MFP 101 using the IC card authentication and the pattern authentication.

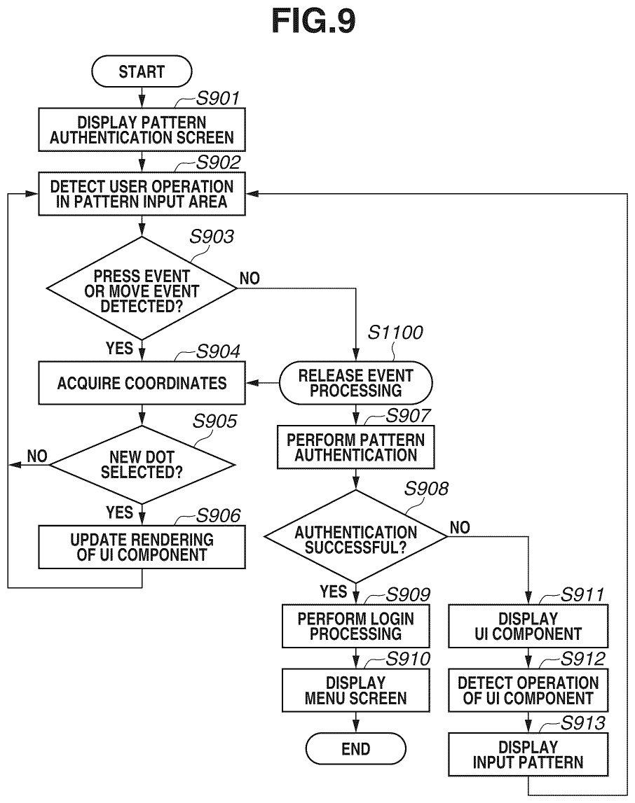

FIG. 9 is a flowchart illustrating an operation performed by the CPU 201 during pattern input in a pattern authentication screen 801 (see FIG. 8).

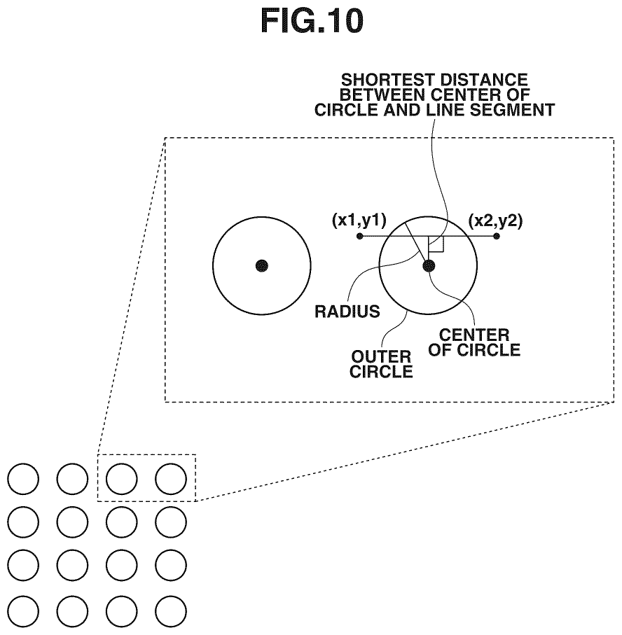

FIG. 10 is a diagram illustrating logic of determining whether a dot is selected by a user in the pattern authentication.

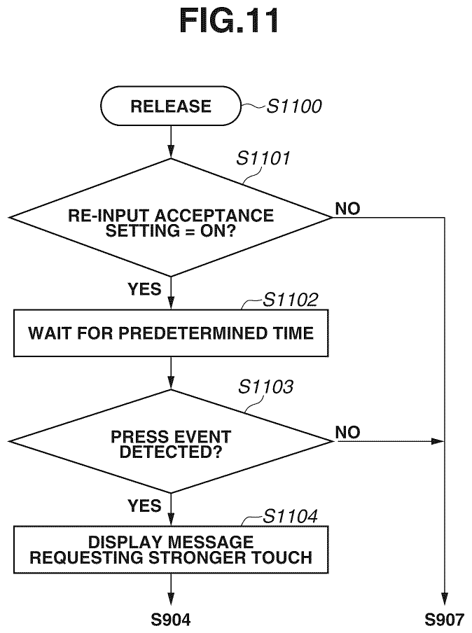

FIG. 11 is a flowchart illustrating a detailed operation in release event processing performed by the CPU 201 in the pattern authentication screen 801.

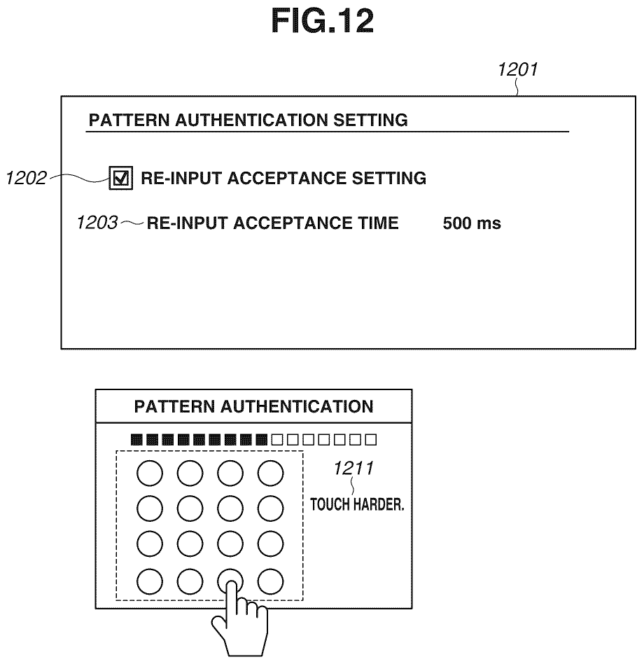

FIG. 12 illustrates an example of a re-input acceptance setting screen in the pattern authentication.

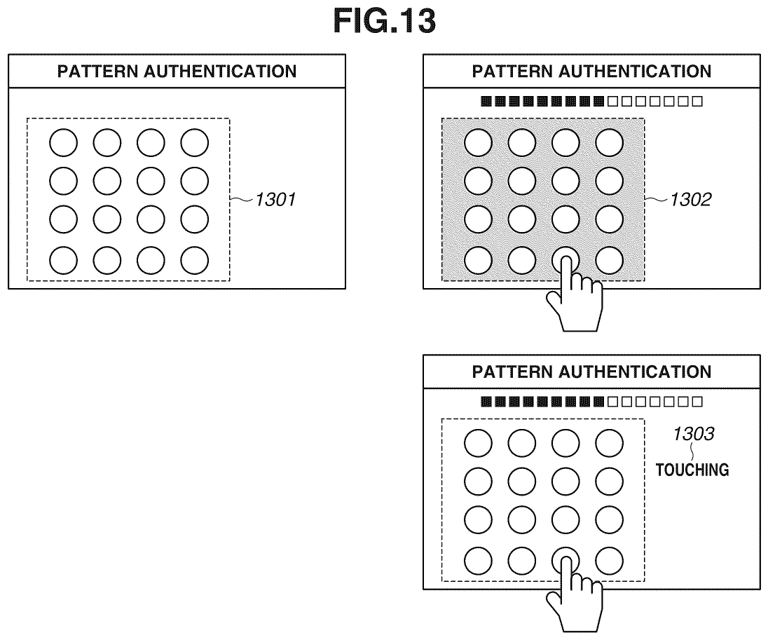

FIG. 13 illustrates an example of switching between screen displays during the input in the pattern authentication.

In the present exemplary embodiment, procedures illustrated in the flowcharts in FIGS. 9 and 11 are recorded in software programs of the local UI 301, the remote UI 302, the login service 303, and the IC card reader driver 304. The software programs are stored in a nonvolatile storage such as the ROM 202 or the HDD 204, and are loaded into the RAM 203 and executed by the CPU 201.

The pieces of software such as the local UI 301, the remote UI 302, the login service 303, and the IC card reader driver 304 provide application programming interfaces (APIs) to each other, and operate in cooperation with each other by mutually using the APIs. In the description of the operation procedure, a description of calling the APIs will be omitted.

As illustrated in FIG. 8, a user tries to log in to the MFP 101 by holding an IC card of the user over the IC card reader 209 in a state where the login screen 604 for the IC card authentication is displayed. The login service 303 acquires card information (such as a card ID) of the held IC card via the IC card reader driver 304. The login service 303 further identifies a user account associated with the acquired card ID by referring to the user account table (Table 1).

At this time, in a case where the card ID is not registered in the user account table (Table 1) and a user account associated with the card ID is not present, the login service 303 displays, on the operation panel 205, an error message (not illustrated) indicating that the IC card is not registered.

In a case where the user account has successfully been identified, the login service 303 confirms that pattern information is registered in the user account table (Table 1) and displays the pattern authentication screen 801 (which corresponds to step S901 in FIG. 9 to be described below).

The pattern authentication screen 801 includes, in addition to a pattern input area indicated by a dotted box and displaying 16 (4×4) dots in FIG. 8, a UI component 802 or a UI component 803 that changes in display depending on the number of selected dots. The user touches the pattern input area displayed on the operation panel 205 with a finger, and slides the finger without releasing the finger from the operation panel 205 (moves the touched position while maintaining the touched state), thereby drawing a pattern shape while selecting dots. In the present exemplary embodiment, in a case where a touch operation is performed on the touch panel, the touch operation will be described using expressions such as “touch” and “release”, but in a case where the touch panel of the operation panel 205 is a pressure-sensitive panel, these expressions mean the following. For example, an expression such as “touching the touch panel with a finger” indicates “pressing the touch panel with predetermined or higher pressure”. An expression such as “releasing the finger from the touch panel” indicates that “pressure of pressing the touch panel becomes less than the predetermined pressure”.

During the pattern input, changing the appearance of selected dots and rendering a line between the dots or a locus thereof are not performed to prevent another user peeking at the operation panel 205 from guessing an input pattern shape based on rendering on the operation panel 205. However, if there is no response from the UI, the user can mistake this situation for hung-up of the UI and feel uneasy, and thus a response is given to the pattern input by changing the rendering of the UI component 802 or the UI component 803.

More specifically, the UI component 802 is a progress bar indicating the progress of the pattern input. For example, if the maximum number of dots of a pattern that can be registered is 16, the progress bar has a scale corresponding to 16 dots, and updates the display of the UI component 802 in a case where a new dot is determined to have been selected by the user during the pattern input. For example, while the user is selecting the dots expressed by “012369cde”, the display of the UI component 802 changes in rendering as indicated by the following Table 3.

TABLE 3

| Selected Dots | Display of UI Component 802 |
|---|---|
| None | □ □ □ □ □ □ □ □ □ □ □ □ □ □ □ □ □ |
| 0 | ▪ □ □ □ □ □ □ □ □ □ □ □ □ □ □ □ □ |
| 01 | ▪ ▪ □ □ □ □ □ □ □ □ □ □ □ □ □ □ □ |
| 012 | ▪ ▪ ▪ □ □ □ □ □ □ □ □ □ □ □ □ □ □ |
| 0123 | ▪ ▪ ▪ ▪ □ □ □ □ □ □ □ □ □ □ □ □ □ |
| 01236 | ▪ ▪ ▪ ▪ ▪ □ □ □ □ □ □ □ □ □ □ □ □ |
| 012369 | ▪ ▪ ▪ ▪ ▪ ▪ □ □ □ □ □ □ □ □ □ □ □ |
| 012369c | ▪ ▪ ▪ ▪ ▪ ▪ ▪ □ □ □ □ □ □ □ □ □ □ |
| 012369cd | ▪ ▪ ▪ ▪ ▪ ▪ ▪ ▪ □ □ □ □ □ □ □ □ □ |
| 012369cde | ▪ ▪ ▪ ▪ ▪ ▪ ▪ ▪ ▪ □ □ □ □ □ □ □ □ |

The number of the scale of the progress bar can be made same as the number of dots of a pattern set by each user, and can be customized based on the pattern set by the user. This makes the user recognize that the input is completed when the display of the progress bar reaches 100%.

The UI component 802 described above is an example of a UI component indicating a response to a pattern input by a user, and any other UI component can be used as long as the UI component can indicate a UI response to the pattern input. The UI component 803 is as an example of such another UI component.

The UI component 803 has an asymmetric appearance, and the rendering is reversed depending on whether the number of selected dots is an even number (including 0) or an odd number. For example, while the user is selecting the dots expressed by “012369cde”, the display of the UI component 803 changes in rendering as indicated by the following Table 4.

TABLE 4

| Selected Dots | Display of UI Component 803 |
|---|---|
| None | ▪ □ |
| 0 | □ ▪ |
| 01 | ▪ □ |
| 012 | □ ▪ |
| 0123 | ▪ □ |
| 01236 | □ ▪ |
| 012369 | ▪ □ |
| 012369c | □ ▪ |
| 012369cd | ▪ □ |
| 012369cde | □ ▪ |

In this manner, the appearance of the UI component 803 is changed each time the user selects a new dot, whereby the user can recognize that the selection operation progresses. In addition, because the total number of selected dots is unclear from the UI rendering, the total number of selected dots is less likely to be recognized by another user, which is safe.

In other words, each time a new dot is selected, the display (e.g., the display indicated in Table 3 or Table 4) based on the number of selected dots is provided on the operation panel 205.

Instead of the UI component such as the UI component 802 or 803 described above, hardware control such as turning-on of light emitting diode (LED) light or oscillation (vibration) can be used to notify the user of the selection of a new button, or the completion of the pattern input.

In the pattern authentication method, ease of authentication depends on the type of the operation panel 205. In general, an electrostatic panel used in a smartphone or the like is compatible with an operation process of moving a finger along the panel because the panel detects an electric current change caused by a finger touch and performs processing. In contrast, a pressure-sensitive panel used in an apparatus such as an automatic telling machine (ATM) of a bank recognizes the pressure of a press on the panel and performs processing. Thus, even though a user thinks the user is moving a finger along the panel, the panel can determine that the finger has been released and the user can fail to draw a pattern. To improve such a case, a re-input acceptance setting 1202 (described in detail below) is provided as indicated in a pattern authentication setting screen 1201 in FIG. 12.

A rendering update operation for the UI component 802 or 803 described above will now be described with reference to a flowchart in FIG. 9, and FIG. 10.

In step S901, the login service 303 displays the pattern authentication screen 801 and waits for a user operation in the pattern input area. In step S902, the login service 303 detects a user operation in the pattern input area. In step S903, the login service 303 determines the type of the detected operation. The main types of the operation are a press event, a move event, and a release event. The press event is an event indicating that a finger of a user has touched the operation panel 205. The move event is an event indicating that the touch position of the finger on the operation panel 205 changes each time the finger slides while being in contact with the operation panel 205. The release event is an event indicating that the finger has been released from the operation panel 205. For example, when the user touches the pattern authentication screen 801 with a finger, the login service 303 is notified of the press event. Each time the finger slides while being in contact with the pattern authentication screen 801, the login service 303 is notified of the move event indicating that the touch position of the finger on the operation panel 205 changes. When the user releases the finger from the pattern authentication screen 801, the login service 303 is notified of the release event.

In a case where the press event or the move event is detected (YES in step S903), the processing proceeds to step S904. In step S904, the login service 303 acquires the coordinates of the current touch position of the finger on the operation panel 205 based on the press event or the move event, and stores the acquired coordinates.

In step S905, the login service 303 determines whether a new dot is selected by the user sliding the finger. In the case of the press event, the login service 303 determines that a new dot is not selected. In the case of the move event, the login service 303 performs the determination as follows.

Depending on the ability of the operation panel 205, not all but some of the coordinate positions touched by the finger of the user can be acquired from the operation panel 205. Thus, for example, assume that, in a case where the coordinates acquired last time based on the move event or the press event are (x1,y1) and the coordinates acquired this time based on the move event are (x2,y2), the finger has passed a line segment connecting the coordinates (x1,y1) and the coordinates (x2,y2) with a straight line. The shortest distance between the line segment connecting the coordinates (x1,y1) and the coordinates (x2,y2) with the straight line and the center coordinates of the circle of a dot is calculated. If the shortest distance is less than the radius of the dot, the login service 303 can determine that the line segment is inside the outer circle and the dot is selected. If the line segment is determined not to be inside the outer circle, or in a case where the dot selected this time and the dot selected last time are the same, the login service 303 determines that a new dot is not selected. In other words, the login service 303 determines whether a new dot is selected based on the locus of the touch position and the display position of the dot on the operation panel 205.

In a case where the login service 303 determines that a new dot is not selected (NO in step S905), the login service 303 terminates the move event processing, and the processing returns to step S902. The login service 303 waits until the next user operation (the press event, the move event, or the release event) is detected.

In a case where the login service 303 determines that a new dot is selected (YES in step S905), the processing proceeds to step S906.

In step S906, the login service 303 stores, in addition to the previously selected dot(s), the selected new dot by being replaced by numeral and alphabet information, and updates the rendering of the UI component 802 or 803 based on the number of selected dots as indicated in Table 3 or 4. The processing then returns to step S902, and the login service 303 waits until the next user operation (the press event, the move event, or the release event) is detected.

In a case where the release event is detected (NO in step S903), the login service 303 performs the release event processing. The release event processing will now be described with reference to FIG. 11.

In step S1101, upon being notified of the release event, the login service 303 determines whether the re-input acceptance setting 1202 (in FIG. 12) is enabled when the finger has been released.

In a case where the re-input acceptance setting 1202 is enabled (YES in step S1101), the processing proceeds to step S1102. In step S1102, the login service 303 waits for a time set as a re-input acceptance time 1203 (in FIG. 12) after the finger is released. In the example of FIG. 12, 500 ms is set as the re-input acceptance time 1203, but can be changed to a desired value by a user. Alternatively, a user can select a desired value from among a plurality of options provided beforehand. Further alternatively, the system can wait for an internally determined time without providing the setting of the re-input acceptance time 1203. Instead of providing a setting such as the re-input acceptance setting 1202, the system can identify the type of the operation panel 205 and enable (turn on) a setting corresponding to the re-input acceptance setting 1202 if the identified type is a specific type, e.g., a pressure-sensitive type. In other words, the system can be configured so that the control in steps S1102 to S1104 is performed if the type of the operation panel 205 is the pressure-sensitive type.

After the login service 303 waits for the predetermined time in step S1102 described above, the processing proceeds to step S1103. In step S1103, the login service 303 determines whether the press event has occurred.

In a case where the press event is detected (YES in step S1103), the login service 303 determines that the user is still in the process of the pattern authentication, and the processing proceeds to step S1104. In step S1104, the login service 303 displays a message requesting a stronger touch, such as a message 1211 illustrated in FIG. 12. The message such as the message 1211 is displayed to clearly notify the user that pressing the touch panel is not enough even though the user thinks the user is moving the finger along the touch panel.

After step S1104 described above, the processing proceeds to step S904 in FIG. 9. In step S904, the login service 303 performs processing similar to the processing in the case of the move event. In other words, in this case, the login service 303 assumes that there is no occurrence of the press event and the touched state continues, and performs control to recognize the locus of the touched position. This makes it possible to continue the pattern input in a case where the press event is detected within the re-input acceptance time 1203 even if the login service 303 is notified of the release event.

In a case where the press event is not detected (NO in step S1103), the processing proceeds to authentication processing in step S907 to be described below.

Also in a case where the re-input acceptance setting 1202 is disabled (NO in step S1101), the processing proceeds to the authentication processing in step S907.

In the above-described example, the message for notifying the user that pressing the touch panel is not enough even though the user thinks the user is moving the finger along the touch panel is displayed, but the following method can also be used.

As another method for improving such a situation that pressing the touch panel is not enough even though the user thinks the user is moving the finger along the touch panel, the following method can be used.

For example, the display form of the pattern authentication screen 801 (e.g., a display color of at least a part of the pattern authentication screen 801) is changed as illustrated in FIG. 13 to make it clear that the finger of the user touches the operation panel 205.

A display 1301 indicates a state where no finger touches the operation panel 205.

A display 1302 indicates a state where a finger of the user touches the operation panel 205.

The display form is changed from the display 1301 to the display 1302 at the timing when the press event indicating that a finger of the user has touched the operation panel 205 is detected. In a case where the release event is detected, the display form is changed from the display 1302 to the display 1301.

A message 1303 saying “touching” can also be displayed to indicate the touch of the finger.

The description now returns to the flowchart in FIG. 9.

After the login service 303 detects the occurrence of the release event in step S903 as described above, the processing proceeds to step S907 in a case where the press event is not detected within the re-input acceptance time 1203 in the release event processing in step S1100.

In step S907, the login service 303 performs pattern authentication by comparing the pre-registered pattern of the user identified based on the IC card authentication with the pattern input in the pattern authentication screen 801 with reference to the user account table (Table 1).

In a case where the patterns match each other as a result of the pattern authentication, the login service 303 determines that the authentication is successful (YES in step S908) and the processing proceeds to step S909.

In step S909, the login service 303 performs processing (login processing) for the successfully authenticated user to log in to the MFP 101. More specifically, the login service 303 loads information about the successfully authenticated user from the user account table (Table 1) into the RAM 203, and instantiates a structure (hereinafter referred to as “login context”) that stores logged-in user information. The information stored in the login context includes a user name, a role, and an e-mail address as indicated by the following Table 5.

TABLE 5

| Item | Value |
|---|---|
| User name | Alice |
| Role | Administrator |
| E-mail address | alice@canon.com |

The login service 303 notifies the local UI 301 of information indicating that the user has logged in to the MFP 101, together with the login context. In step S910, the local UI 301 displays the menu screen 601, and the processing of this flowchart ends.

In a case where the pre-registered pattern and the input pattern do not match each other in step S908, the login service 303 determines that the authentication is unsuccessful (NO in step S908), and the processing proceeds to step S911.

In step S911, the login service 303 updates rendering in a pattern authentication screen 804 and displays a UI component 805. The UI component 805 is a button for checking the shape of the pattern input immediately before by the user.

In step S912, the login service 303 detects the operation of the UI component 805 performed by the user. In step S913, the login service 303 displays the shape of the pattern input by the user by changing the appearance of selected dots and rendering a line between the dots or a locus thereof. For example, in a case where the button of the UI component 805 is pressed, the login service 303 displays the shape of the pattern input by the user by changing the appearance of the selected dots and rendering the line between the dots or the locus thereof, as indicated by a pattern authentication screen 806. After step S913 described above, the processing returns to step S902. In step S902, the login service 303 waits until the next user operation (the press event, the move event, or the release event) is detected.

In a case where touching the pattern input area with the user's finger again is detected during the rendering in the pattern authentication screen 804 or 806, the login service 303 stops rendering the UI component 805 or rendering the shape of the pattern input by the user, and returns the current display state to the display state of the pattern authentication screen 801. The press event, the move event, or the release event is then processed again.

In a case where the pattern authentication is unsuccessful (NO in step S908), instead of displaying the UI component 805 to prompt the user to press the button of the UI component 805, the login service 303 can automatically render the pattern input to the UI only for a predetermined time (e.g., two seconds). Alternatively, the login service 303 can display the input pattern only while a predetermined button (e.g., the UI component 805) is touched.

While the example using “IC card authentication” has been described with reference to FIG. 8, the operation after the display of the pattern authentication screen 801 is similarly performed also in a case where “simple login” and the pattern authentication are used in combination. In a case where “simple login” and the pattern authentication are used in combination, the user account to be used for the pattern authentication is identified based on the button pressed by the user in the simple login screen 603 instead of using the IC card.

In the exemplary embodiment described above, when the release event indicating the release of a finger from the operation panel 205 is detected, the authentication processing continues if the finger touches the operation panel 205 again within the predetermined time provided as the re-input acceptance time 1203. In other words, the MFP 101 according to the present exemplary embodiment inputs, in response to an input operation of touching the operation panel 205 and moving the touched position while maintaining the touched state, the pattern information determined based on the locus of the touched position. If the operation panel 205 is touched again within the predetermined time after the touched state is released, the input control to recognize the locus of the touched position is performed assuming that the touched state continues without being released.

Such a configuration can address the issue that pressing the operation panel 205 is not enough even though a user thinks the user is moving a finger along the operation panel 205. In addition, such a configuration enables the user to recognize whether the current state is a state of touching the operation panel 205, by changing the display between when a finger touches the operation panel 205 and when no finger touches the operation panel 205. This also increases convenience.

In this way, the present exemplary embodiment can enhance usability in pattern authentication performed by moving a finger along an operation panel.

The structures of various kinds of data described above and the contents thereof are not limited to those described above, and various structures and contents can be used depending on the use and the purpose.

While one exemplary embodiment of the present disclosure has been described above, the present exemplary embodiment can take the form of, for example, a system, an apparatus, a method, a program, or a storage medium. More specifically, the present exemplary embodiment can be applied to a system including a plurality of apparatuses, or can be applied to a single apparatus.

In addition, all configurations obtained by combining the above-described exemplary embodiments are also included in exemplary embodiments of the present disclosure.

An exemplary embodiment of the present disclosure can also be implemented by processing of supplying a program for implementing one or more functions according to the above-described exemplary embodiments to a system or an apparatus via a network or a storage medium, and causing one or more processors in a computer of the system or the apparatus to read and execute the program. An exemplary embodiment of the present disclosure can also be implemented by a circuit (e.g., an ASIC) for implementing the one or more functions.

In addition, the exemplary embodiments of the present disclosure can each be applied to a system including a plurality of apparatuses, and to a single apparatus.

The present disclosure is not limited to the above-described exemplary embodiments, and various modifications (including organic combinations of the exemplary embodiments) can be made within the spirit of the present disclosure and are not excluded from the scope of the exemplary embodiments of the present disclosure. Configurations obtained by combining the above-described exemplary embodiments and modifications thereof are all included in the exemplary embodiments of the present disclosure.

The exemplary embodiments of the present disclosure can enhance usability in an operation of drawing a pattern by moving a finger along a panel.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-117536, filed Jul. 22, 2022, which is hereby incorporated by reference herein in its entirety.

What is claimed is:

1. An information processing apparatus comprising:
one or more processors; and
at least one memory coupled to the one or more processors and having stored thereon instructions which, when executed by the one or more processors, cause the information processing apparatus to:
perform control to input pattern information in response to an input operation of touching an operation unit and moving a touched position of the operation unit while maintaining a touched state of the operation unit, the pattern information being determined based on a locus of the touched position,
wherein, in a case where there is a touch on the operation unit within a predetermined time after the touched state is released, input control to recognize the locus of the touched position is performed assuming that the touched state continues without being released.

2. The information processing apparatus according to claim 1, wherein, in the input control, the locus of the touched position is recognized assuming that the touched position has moved from a position at which the touched state is released to a position at which the touch has occurred within the predetermined time after the touched state is released.

3. The information processing apparatus according to claim 2, wherein the input operation for the pattern information is accepted in a state where a plurality of display objects is displayed on the operation unit, selection of a display object from among the plurality of display objects is determined in response to the input operation based on the locus of the touched position and a display position of the display object, and the pattern information about the selected display object is input.

4. The information processing apparatus according to claim 3, wherein a display on the operation unit is changed each time a new display object is selected from among the plurality of display objects.

5. The information processing apparatus according to claim 4, wherein a display based on a number of display objects selected from among the plurality of display objects is performed on the operation unit each time a new display object is selected from among the plurality of display objects.

6. The information processing apparatus according to claim 1, wherein a display on the operation unit is changed between the touched state of the operation unit and a non-touched state of the operation unit.

7. The information processing apparatus according to claim 6, wherein in changing the display on the operation unit, a color of at least a part of a screen displayed on the operation unit is changed.

8. The information processing apparatus according to claim 1, wherein the instructions further cause the information processing apparatus to:
perform authentication by comparing the input pattern information and pre-registered pattern information; and
perform rendering based on the input pattern information on the operation unit in a case where the authentication is unsuccessful.

9. The information processing apparatus according to claim 1, wherein the input control is performed in a case where the operation unit is a pressure-sensitive operation unit.

10. The information processing apparatus according to claim 1, wherein the instructions further cause the information processing apparatus to:
make a setting about the input control on the operation unit; and
perform the input control in a case where the setting is made.

11. A method for controlling an information processing apparatus including an operation unit configured to be operated by touch, the method comprising:
performing control to input pattern information in response to an input operation of touching an operation unit and moving a touched position of the operation unit while maintaining a touched state of the operation unit, the pattern information being determined based on a locus of the touched position,
wherein, in a case where there is a touch on the operation unit within a predetermined time after the touched state is released, input control to recognize the locus of the touched position is performed assuming that the touched state continues without being released.

12. A non-transitory computer-readable storage medium storing a program for causing a computer to execute a method for controlling an information processing apparatus including an operation unit configured to be operated by touch, the method comprising:
performing control to input pattern information in response to an input operation of touching an operation unit and moving a touched position of the operation unit while maintaining a touched state of the operation unit, the pattern information being determined based on a locus of the touched position,
wherein, in a case where there is a touch on the operation unit within a predetermined time after the touched state is released, input control to recognize the locus of the touched position is performed assuming that the touched state continues without being released.
